(19) United States
(12) Patent Application Publication
(10) Pub. No.: US 2016/0055836 A1
(43) Pub. Date: Feb. 25, 2016

(54) Visual Sound Tower

(71) Applicant: Patrick Authement, San Antonio, TX (US)

(72) Inventor: Patrick Authement, San Antonio, TX (US)

(21) Appl. No.: 14/806,800

(22) Filed: Jul. 23, 2015

Related U.S. Application Data
(60) Provisional application No. 62/040,662, filed on Aug. 22, 2014.

(51) Int. Cl. G10H 1/00; H04R 29/00

(52) U.S. Cl. CPC G10H 1/0008; H04R 29/008; G10H 2220/021

(57) ABSTRACT

A device for visually indicating the ambient noise level is provided. The device includes an elongated cylinder having a plurality of sections. The plurality of sections are in a stacked configuration and includes a lower section, a middle section, and an upper section. A plurality of lights are disposed in each section of the elongated cylinder. The plurality of sections are configured to illuminate at each section of the elongated cylinder corresponding to a predetermined noise level. A control box is in electrical communication with the lights disposed in the elongated cylinder. The control box includes a microphone, a power source and a control circuit. The elongated cylinder provides a visual indication of the sound level via the illuminated sections which correspond to the noise level detected by the microphone.

### CROSS REFERENCE TO RELATED APPLICATION

This application claims the benefit of U.S. Provisional Application No. 62/040,662 filed on Aug. 22, 2014. The above identified patent application is herein incorporated by reference in its entirety to provide continuity of disclosure.

### FIELD OF THE INVENTION

The invention generally relates to a visual indicator for the ambient noise level. More specifically, the present invention relates to an elongated cylindrical tower having a plurality of sections that provide an illuminating indication of the ambient noise level.

### BACKGROUND OF THE INVENTION

Musicians are often required to play portions of a song at different relative volume levels that may be constantly changing throughout a performance. Some keynotes must be performed relative softly, while others are performed relative loudly, and many songs vary in volume throughout a single performance. However, some musicians may have difficulty determining how loudly they are playing when they are focused on playing their instrument, while concurrently reading complex sheet music. Therefore, there exists a need for a device that provides a user with a visual indicator that is reflectively of their relative volume.

Existing sound devices in the prior art do not have the means for responding visually to the amplitude variations of the music at predetermined noise levels. Some devices use the visual display merely as an output level meter for the two output channels of a stereo amplifier for the purpose of balancing the sound level outputs of each of the two stereo amplifiers. Other visual light devices are responsive to audio input signals are known in the prior art. U.S. Pat. No. 3,480,912 issued to Speeth et al. discloses a visual sound level indicator for use in a classroom to indicate to a pupil when he or she is speaking loud enough. The indicator has a semi-transparent front panel divided into parallel strips each of a different color with an indicating lamp behind each strip.

U.S. Pat. No. 4,614,942 issued to Molinaro describes a visual sound device for use in the visual interpretation of a received electrical sound signal, which has an electro visual means that responds visually in amplitude to the amplitude variations of the intelligence contained within a band of frequencies contained within the frequency spectrum of a received electrical sound signal.

These prior art devices, however, fail to provide or teach a visual light output, which varies in intensity and responds in real time to a received audio input signal. Additionally, other prior art devices only have a function in response to a specific instrument (i.e. microphone). Prior art devices are primarily frequency dependent, wherein their respective lights are typically only in activated or deactivated states. Therefore, the invention provided in the present disclosure is an effective resolution of the aforementioned problems and shortcomings that the present invention is directed.

In light of these devices disclosed in the prior art, it is submitted that the present invention substantially diverges from the prior art and consequently it is clear that there is a need in the art for an improvement to existing visual devices indicating the ambient noise level. In this regard the instant invention substantially fulfills these needs.

### SUMMARY OF THE INVENTION

In view of the foregoing disadvantages inherent in the known types of visual sound aids now present in the prior art, the present invention provides an improved visual indicator for indicating the sound level wherein the same can be utilized for providing convenience for a musician when performing by providing a visual indication of their volume.

It is therefore an object of the present invention to provide a new and improved visual sound indicator that has all of the advantages of the prior art and none of the disadvantages.

It is a first object of the present invention to provide a device for visually indicating the ambient noise level. The device includes an elongated cylinder having a plurality of sections. The plurality of sections are in a stacked configuration. The plurality of sections include a lower section, a middle section, and an upper section, wherein the lower section is indicative of lower noise levels and the upper section is indicative of high noise levels.

It is another object of the present invention to provide a device for visually indicating the ambient noise level that includes a plurality of lights disposed in each section of the elongated cylinder. The plurality of lights flash on and off at each section of the elongated cylinder corresponding to a noise level.

It is yet another object of the present invention to provide a device for visually indicating the ambient noise level that includes a control box in electrical communication with the lights disposed in the elongated cylinder. The control box includes a microphone, an amplifier and a microprocessor. The microphone is adapted to sample and measure sound waves, and transmit an electrical signal to an amplifier that intensifies the electrical signal. The amplified electrical signal is transmitted to the microprocessor to convert the amplified electrical signal to an output signal indicative of the ambient noise level. The output signal is transmitted to the plurality of lights and is indicative of the plurality of lights to be activated

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the transparent visual sound tower according to one embodiment of the invention.

FIG. 2 shows a perspective view of the illuminated visual sound tower according to one embodiment of the invention.

FIG. 3 shows a schematic of the control box of the visual sound tower according to one embodiment of the present invention.

### DETAILED DESCRIPTION OF THE INVENTION

Reference is made herein to the attached drawings. Like reference numerals are used throughout the drawings to depict like or similar elements of the visual sound tower. For the purposes of presenting a brief and clear description of the present invention, the preferred embodiment will be discussed as used for indicating the ambient noise level. The figures are intended for representative purposes only and should not be considered to be limiting in any respect.

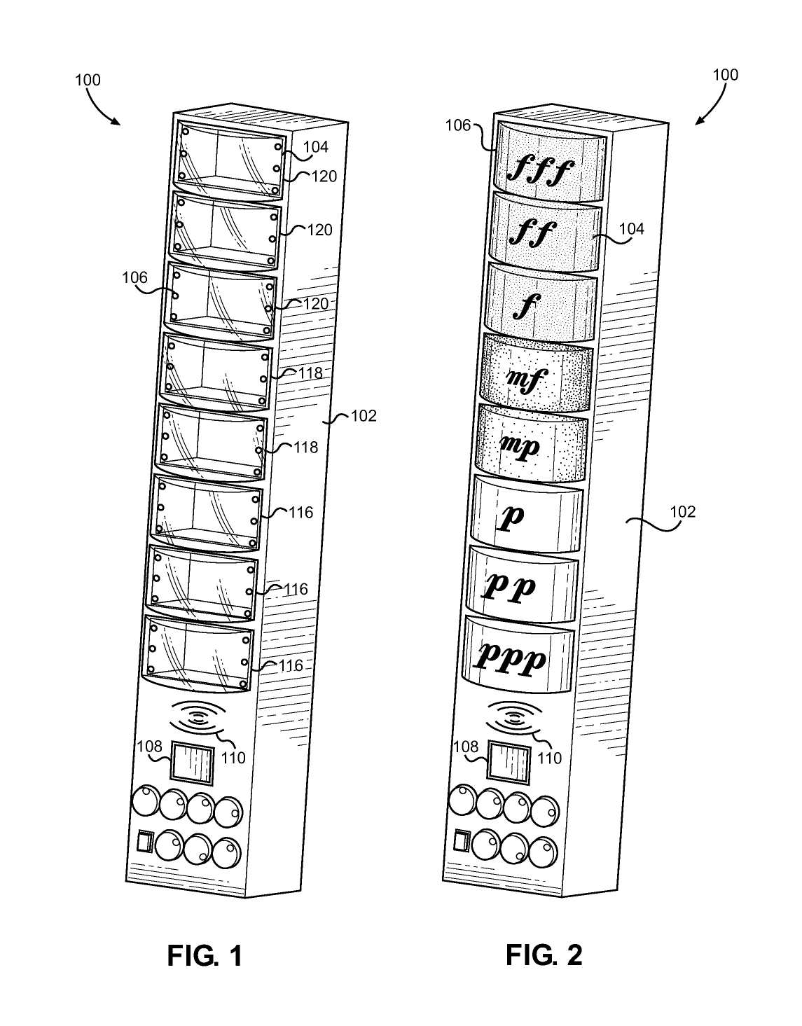

Referring now to FIG. 1, there is shown a perspective view of the transparent visual sound tower according to one embodiment of the invention. The device 100 for visually indicating the ambient noise level includes an elongated cylinder 102. The elongated cylinder 102 has a plurality of sections 104 that are in a stacked arrangement that form the elongated cylinder 102. The elongated cylinder 102 extends vertically from the control box 108 positioned below the elongated cylinder 102. The control box 108 includes a microphone, an amplifier and a microprocessor. The plurality of sections 104 are in electrical communication with the control box 108.

The plurality of sections 104 are arranged into a lower section 116, a middle section 118, and an upper section 120, wherein the lower section 116 includes at least three sections 104 that are stacked on one another. The lower section 116 is preferably disposed above the control 108 and is configured to correspond with lower volume on a sound level meter. The middle section 118 includes at least two stacked sections 104 positioned above the lower section 116 and is configured to correspond with moderate volume of noise. The upper section 120 is preferably situated above the middle section 118 and corresponds to a loudest setting of noise. Preferably, the upper section 120 includes at least three sections 104 that are stacked on one another.

The plurality of sections 104 include dynamic indications that are labeled thereon to specify relative loudness. These indications range from “fff” to “ppp.” One indication is “p” or piano, meaning soft. Another indication is “f” or forte, meaning loud. More subtle degrees of loudness or softness are indicated by: “mp”, standing for mezzo-piano, meaning “moderately soft”; and “mf”, standing for mezzo-forte, meaning “moderately loud.” Beyond f and p, there are also indications: “pp”, standing for “pianissimo” and meaning “very soft”; “ff”, standing for “fortissimo” and meaning “very loud”; “ppp”, standing for “pianississimo” and meaning “very very soft”; and “fff”, standing for “fortississimo” and meaning “very very loud.”

Referring now to FIG. 2, there is shown a perspective view of the illuminated visual sound tower according to one embodiment of the invention. The elongated cylinder 102 has a plurality of sections 104 that are configured to illuminate at the lower section 116, middle section 118, and upper section 120 at a predetermined noise level. The plurality of sections illuminate to provide a different color at each section of the elongated cylinder. The sections that illuminate are contingent on the ambient noise level detected by the microphone 110.

A plurality of lights 106 are disposed in each section of the elongated cylinder 102. Each section 104 of the elongated cylinder have lights 106 surrounding the periphery of the section. The lights 106 flash at different sections according to the ambient noise level determined by the microprocessor via the microphone 110.

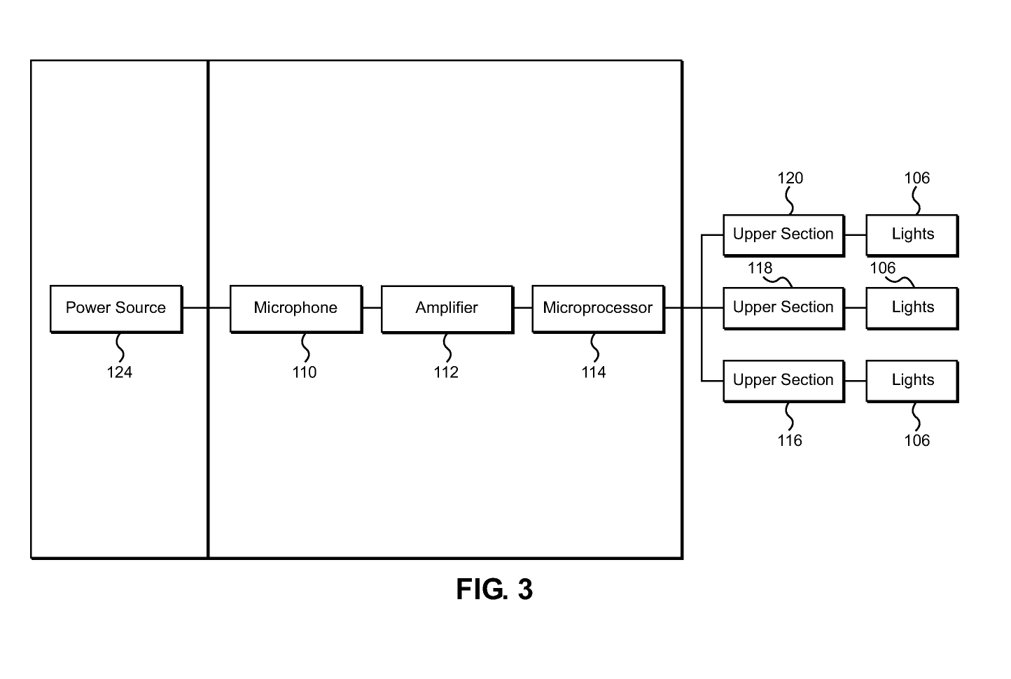

Referring now to FIG. 3, there is shown a schematic of the control box of the visual sound tower according to one embodiment of the present invention. The control box 108 includes a microphone 110, an amplifier 112 and a microprocessor 114. The microphone 110 is adapted to sample and measure sound. Furthermore, the microphone 110 is configured transmit an electrical signal to the amplifier 112 that is operatively connected to the microphone 110. The amplifier 112 is configured to receive the electrical signal from the microphone 110 and amplify the electrical signal. The microprocessor 114 converts the electrical signal to an output signal indicative of the ambient noise level. The power source 124 is in electrical communication with all the components within the control box 108.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A device for visual indicating the ambient noise level, comprising:
an elongated cylinder comprising a plurality of sections, wherein the plurality of sections are in a stacked configuration;
a plurality of lights disposed in each section of the elongated cylinder;
a control box in electrical communication with the lights disposed in the elongated cylinder, the control box including a microphone, an amplifier and a control circuit;
wherein the plurality of sections include a lower section, a middle section, and an upper section;
wherein the plurality of sections are configured to illuminate at the lower section, middle section, and upper section at a predetermined noise level.

2. The device of claim 1, wherein the lower section includes at least three stacked sections positioned above the control box and corresponds to a low volume.

3. The device of claim 1, wherein the middle section includes at least two stacked sections positioned above the lower section and corresponds to a moderate volume.

4. The device of claim 1, wherein the upper section includes at least three stacked sections positioned above the lower section and corresponds to a high volume.

5. The device of claim 1, wherein the plurality of sections illuminate to provide a different color at different sections of the elongated cylinder.

6. The device of claim 1, wherein the plurality of sections include dynamic indications that specify relative loudness.

7. The device of claim 1, wherein the microphone is adapted to sample and measure soundwaves, and transmitting an electrical signal to the amplifier.

8. The device of claim 7, wherein the amplifier is operatively connected to said microphone and is configured to receive and amplify the electrical signal.

9. The device of claim 8, wherein the microprocessor is configured to transmit an electrical signal to an output signal indicative of the ambient noise level;
wherein said output signal is configured to be indicative of the plurality of lights to be activated.
